(19) United States
(12) Patent Application Publication
(10) Pub. No.: US 2011/0069921 A1
(43) Pub. Date: Mar. 24, 2011

(54) BEARING FOR A VACUUM ROLLER THAT CAN BE SUBJECTED TO SUCTION AIR FROM BOTH SIDES

(75) Inventor: Reinhard Raueiser, Muden (DE)

(73) Assignee: WINKLER + DUNNEBIER AG, Neuwied (DE)

(21) Appl. No.: 12/994,490

(22) PCT Filed: May 19, 2009
(86) PCT No.: PCT/EP2009/003569

§ 371 Date: Nov. 24, 2010

(30) Foreign Application Priority Data
May 28, 2008 (DE) 10 2008 025 490.8

(51) Int. Cl. F16C 33/46

(52) U.S. Cl. 384/572

(57) ABSTRACT

A bearing structure has a frame, a vacuum roller mounted on the frame, operable to be axially subjected to suction air from both sides, a first bearing arranged in a first bearing housing and a second bearing arranged in a second bearing housing, and a first bearing journal disposed on a first end of the roller, and a second bearing journal disposed on a second end of the roller. The roller is mounted in the first bearing so that there is a substantially constant clearance between a first front face of the roller. The roller is mounted in the second bearing so that there is a substantially constant separation between a second front face of the roller. The second bearing housing is arranged such that the second bearing housing is axially displaceable relative to the frame.

### FIELD OF THE INVENTION

The invention relates in general to a bearing for a vacuum roller that can be subjected to low pressure and particularly to a bearing for a vacuum roller that can be subjected to low pressure from both sides.

### BACKGROUND

When transporting flat materials, for example, blanks in the manufacture of envelopes, labels or the like, so-called vacuum rollers are commonly used. These rollers present in their lateral surfaces so-called suction air openings or suction holes which are subjected to low pressure (“suction air”), where the suction action communicated in this way holds the products to be transported on the lateral surface of the vacuum roller.

The suction holes here are in connection with axial suction air ducts running inside the roller, where the suction air ducts open on one of the front faces of the suction roller. A selective application of a low pressure (and/or optionally compressed air) to individual suction air ducts distributed over the periphery of the roller body occurs here usually via a so-called control disk and/or control valves, where, by means of these components, it becomes possible, on the one hand, to adapt the vacuum roller to different format settings, and, on the other hand, to carry out the application over different angular sectors of the rotation of the roller.

Thus, for example, the roller can be subjected over a first angular sector of its rotation to low pressure/suction air, in order to hold products on the lateral surface of the roller, while a second angular sector of the rotation is subjected to compressed air, in order to detach the products from the lateral surface.

In this sense, a “control disk” does not have to extend like a disk over an angular range of 360°, if the roller is not to be subjected to suction air/compressed air over the entire periphery; rather, the disk can also be in segment form, for example, in the shape of a horseshoe.

In order to communicate the low pressure generated by stationarely arranged pumps or the like to the rotating front face of the roller, or to the openings of the suction air ducts arranged on the roller, the front face and the stationarely arranged components which face them, and which apply the low pressure, are usually sealed by means of a contact-free slot sealing.

In this sense, although the rotating front face and the stationarely arranged components are separated from each other, so that a contact-free rotation of the front face becomes possible; however, the separation is chosen to be as small as possible, in order to keep the degradation of the low pressure, which occurs as a result of the forming slot as small as possible. Typical widths of these slots, also referred to as suction slot, are in the range of a few hundredths of a millimeter.

For the construction and/or setting of an appropriate slot sealing, a great variety of methods are known from the state of the art, see, for example, DE 10 2004 044 803 A1, so that a detailed description is omitted here.

To ensure as constant and reproducible a functioning of the vacuum roller as possible, one must ensure that the slot, between the front face of the roller and the stationarely arranged components which face the front face and communicate the low pressure, remains substantially constant.

To achieve this, the bearing of the roller, in which the roller journal (hereafter referred to as the first bearing) is associated with the front face to be subjected to low pressure, is usually designed as a fixed bearing with respect to an axial displacement of the roller, that is the roller cannot be displaced in the axial direction with respect to the bearing.

However, because potentially occurring, thermally caused, axial length changes of the roller must be compensated, the entire bearing arrangement of the vacuum roller is designed as a floating bearing, that is the second bearing which faces the first bearing allows an axial displacement of the roller relative to the bearing or to the respective bearing housing. This can occur either by means of a bearing in which an outer ring and inner ring are mutually displaceable, or a self holding bearing with a sliding fit of the point loaded ring.

However, subjecting the vacuum roller to low pressure from one side, as has been done to date, has considerable drawbacks in some applications.

Because of the continually increasing cycle numbers, for example, in the production of labels or envelopes, the rotation speeds of vacuum rollers in the machine work cycle continue to increase. This leads to the need to generate or degrade the low pressure in the suction air ducts in correspondingly shorter times. Moreover, the vacuum rollers, in terms of their axial extent, have continued to become longer in the past years due to technical progress and in accordance with the dimensions of the products to be transported.

The result of the two above-mentioned points is that, if the vacuum roller is subjected to low pressure from one side, there is no longer any guarantee that the axial suction air ducts can be subjected uniformly to low pressure over the entire axial extent. Accordingly, the result can be different suction effects in the axial direction of the roller.

Consequently, the question of how to subject vacuum rollers on both sides to low pressure has already been studied in the past, for the purpose of achieving a uniform suction effect over the entire axial dimension of the vacuum roller.

However, because of the above-described communication of the low pressure from components that are stationarely arranged to the openings of the suction air ducts, which openings are arranged on the rotating front face, using, on the one hand, a slot sealing, and, on the other hand, the required functionality as a floating bearing of the second bearing because of the thermal length changes of the roller body, in the second bearing, a constant width of the suction slot cannot be maintained.

Thus, in the case of a thermal expansion of the roller body, a contact between the sealing surfaces and jamming of the sealing surfaces can occur, if the chosen slot width is not sufficiently large.

In the state of the art, the wear of the sealing surfaces due to the use of a contact sealing is accepted. However, once wear of the sealing surfaces has occurred due to expansion, it can no longer be corrected, so that, in the case of thermal changes which result in a shortening of the roller length, the slot presents an undesirably large width, which can lead to increased degradation of the low pressure in the transition from stationary to rotating components, and thus to increased performance requirements for the pump systems or to an unsatisfactory suction effect for the products.

### SUMMARY OF THE INVENTION

According to one or more embodiments of the present invention, a bearing arrangement for a vacuum roller can be subjected to suction air from both sides, and which ensures, even in the case of thermally caused changes in the length of the roller, an unimpeded rotation of the roller, and also a constant communication of low pressure to the suction air ducts arranged in the roller.

The bearing arrangement according to one or more embodiments of the invention for mounting a vacuum roller which can be subjected to suction air from both sides in a frame presents two bearings which are each arranged in a bearing housing. Here, one usually uses conventional roller bearings, which are known to the person skilled in the art in connection with the mounting of vacuum rollers.

The roller to be mounted presents at each of its ends a bearing journal, each of which is received by one of the two bearings. According to one or more embodiments of the invention, the roller in both bearings is mounted so it cannot be displaced relative to the respective bearing in the axial direction, so that, on each side of the roller, there is a substantially constant separation between the front face of the roller, which radially surrounds the respective journal, and the stationarely arranged components which face the front face, and which subject the front face of the roller to suction air. The functionality as a floating bearing of the bearing, which is required for a compensation of thermal expansions of the roller body, is achieved according to one or more embodiments of the invention by an arrangement allowing axial displacement of one of the two bearing housings relative to the frame in which the bearing is mounted.

In other words, both roller journals, with regard to the respective front face of the roller, are provided with a fixed bearing, while a floating bearing is implemented between a bearing housing and the frame of a floating bearing.

In this way, it is guaranteed that the slot sealing between the rotating and the stationary components for subjecting the suction roller to suction is largely independent of any change in the length of the roller caused by thermal influences, because the separation of the components remains constant due to the fixed bearing functionality.

Only thermally caused changes in the length of the section of the roller journal located between the contact point of the roller journal in the bearing and the front face of the roller can have an effect on the width of the slot sealing. However, this effect is negligible in comparison to the effect of a length expansion of the entire roller body, and, in the case of a basic setting of the width of the slot sealing, it can also be taken into account accordingly, so that no relevant changes in the suction air transfer performance or the like can occur during operation.

It is advantageous here that the bearing housing which is axially displaceable in relation to the frame is prestressed in the radial direction against the frame. In this manner, the axial displaceability of the bearing housing according to one or more embodiments of the invention with respect to the frame can be achieved by the remaining clearance in the axial direction, while simultaneously a sufficient radial fixation of the bearing housing and thus of the bearing occurs.

This prestressing can occur by means of any possible suitable stressing elements, where, according to one or more embodiments of the invention, spring packets are used consisting of plate springs, to prestress the bearing housing radially against the frame.

In one or more embodiments of the invention, the radial prestressing of the housing against the frame occurs in the direction in which the weight of the roller also acts on the bearing and thus on the bearing housing as well as the frame, that is downwards, to be able to exploit both effects combined.

In order to ensure the axial displaceability of the bearing housing according to one or more embodiments of the invention with respect to the frame, even in the case of a radial fixation of the housing, for example, by the above-described radial prestressing, at least one of the contact surfaces may be provided between the axially displaceable bearing housing and the frame with an adhesive force- and/or friction force-reducing element.

Usually, in the case of a prestressing of the housing against the frame in the radial direction, the contact surfaces involved here are those exposed to an additional force due to the prestressing.

As adhesive force- and/or friction force-reducing element, one can use, in the simplest case, a grease-based lubricant or the like. However, it would also be conceivable to design the contact surface as a roller bearing, a slide bearing or the like, to function as the adhesive force- and/or friction force-reducing element.

According to an additional aspect of the present invention, for the purpose of controlling the manner in which the two front faces of the roller are subjected to suction air, a control disk is used in each case, which is stationarely arranged on the respective bearing housing and which faces the respective front face of the roller.

According to one or more embodiments of the invention, a stationary arrangement of the control disk on the surface of the bearing housing, which faces in each case the front face of the roller, has the advantage that the length of the roller and thus of the rotating components can be reduced, which stabilizes the externally located bearing of the roller.

### BRIEF DESCRIPTION OF DRAWINGS

FIG. 1 shows a general view, shown partially in cross section and partially in a lateral view, of the cutting station with the vacuum roller mounted according to one or more embodiments of the invention; and

FIG. 2 shows a detail of the bearing housing of the cutting station from FIG. 1, which bearing housing can be axially displaced with respect to the frame according to one or more embodiments of the invention.

### DETAILED DESCRIPTION

Exemplary embodiments of the invention will be described with reference to the accompanying figures. Like items in the figures are shown with the same reference numbers. In embodiments disclosed herein, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

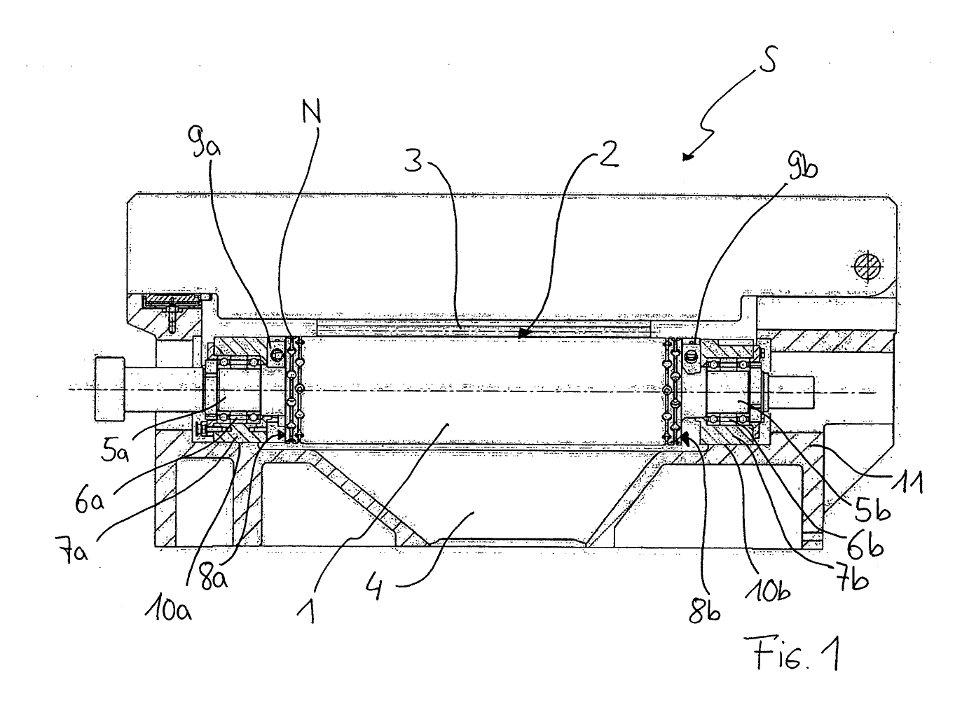

FIG. 1 shows a so-called cutting bridge S, as used in a cutting station for manufacturing envelopes. With the vacuum roller 1, which in this case is designed as a knife roller, that is which carries a cutting tool on its lateral surface, the window cutouts of the envelopes are cut out of supplied envelope blanks by means of the cutting tools which rotate in a cutting slot 2 against a fixed cutting bar 3. The cutout window areas are then held by means of suction air on the lateral surface of the roller 1, and transported over a predetermined angular sector, before they are delivered for waste disposal downwards into a funnel 4.

The roller 1 is here mounted on the left side in FIG. 1 with its roller journal 5a in a first bearing 6a and on the right side in FIG. 1 with its roller journal 5b in a second bearing 6b. The two bearings 6a, 6b are each a two-row ball bearing, and arranged in a bearing housing 7a, 7b.

The present two bearings 6a, 6b are applied with stress against the bearing housings 7a, 7b, that is the bearings 6a, 6b and thus the journals 5a, 5b cannot be displaced in an axial direction relative to the bearing housings 7a, 7b. In this sense, the bearings 6a, 6b are designed as fixed bearings in the axial direction.

The two bearing housings 7a, 7b are here designed with annular shape, and in each case located in a semicircular recess 10a, 10b of the frame 11 of the cutting bridge S.

The roller 1 here presents the suction air ducts (not shown) which are usually present in vacuum rollers, extending axially from the front faces 8a, 8b of the roller 1, and which are in connection with suction air openings (not shown) in the lateral surface of the roller 1.

At each of the two ends of the roller 1, two rows of control valves acting on the individual suction air ducts are arranged, which are accessible via respective grooves and bores N in the lateral surface of the roller 1.

On each of the surfaces of the roller housings 7a, 7b, which face the respective front face 8a, 8b, a control disk 9a, 9b is arranged, which presents inner areas which can be subjected to suction air, and which are designed facing the suction air ducts of the roller, which open on the respective front face 8a, 8b.

None of the two control disks 9a and 9b extends, in the represented embodiment, over 360°, rather they are both designed in segment form, where the control disk 9b arranged on the right in FIG. 1 covers a smaller angular range than the control disk 9a arranged on the left.

The slot sealing, which is required in the present case for the communication of suction air, between the rotating roller and the control disks 9a, 9b which are stationarely arranged on the bearing housings 7a, 7b, is formed by the separation A (“suction slot”) which is present between the respective front face 8a, 8b and the surface of the control disks 9a, 9b, which faces said front face.

This separation A, due to the fixed bearing function of the bearings 6a, 6b respectively of the front faces 8a, 8b of the rollers 1, is substantially independent of thermally caused length changes of the roller 1, and it can be produced or set for the usual processes, in such a way as to present as small as possible a size.

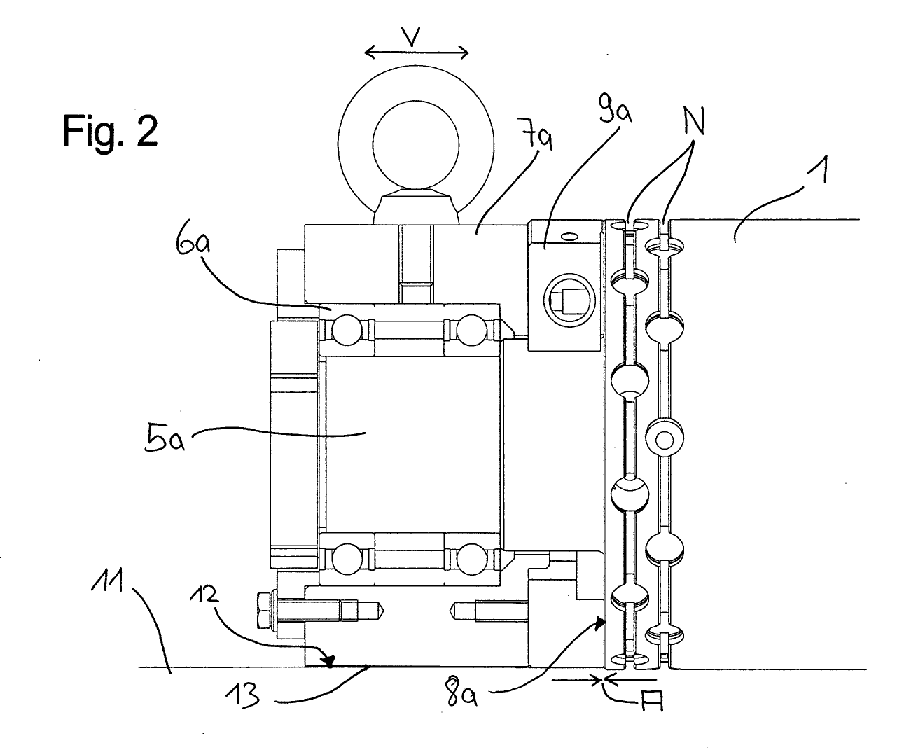

In FIG. 2, the bearing 6a arranged on the left in FIG. 1 is represented in detail. The bearing 6a, in the present embodiment, fulfills the floating bearing function according to one or more embodiments of the invention with respect to the frame 11, that is the bearing housing 7a is axially displaceable relative to the frame 11, as indicated by the arrow V in FIG. 2.

In contrast, the bearing housing 7b arranged on the right in FIG. 1 is arranged in a way which allows no axial displacement with respect to the frame 11; rather, it is fixed axially with respect to the frame, in order to ensure a reproducible axial position of the roller 1.

To ensure a radial fixation of the axially displaceable bearing housing 7a, the bearing housing 7a is prestressed in the radial direction by means of plate springs (not shown) with appropriate radially acting screw connections against the frame 11.

Here, the contact surface 12 between the bearing housing 7a and the frame 11 is greased with assembly paste 13, to ensure an axial displaceability of the housing 7a in spite of radial prestressing.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### LIST OF REFERENCE NUMERALS

S Cutting bridge
1 Roller
2 Cutting slot
3 Cutting bar
4 Funnel
5a, b Roller journal
6a, b Bearing
7a, b Bearing housing
8a, b Front faces of 1
9a, b Control disks
10a, b Recess in 11
11 Frame
12 Contact surface
13 Lubricant
A Suction slot
V Axial displaceability of 7a
N Grooves/bores in 1

1. A bearing structure for a frame comprising:
a vacuum roller mounted on the frame, operable to be axially subjected to suction air from both sides;
a first bearing arranged in a first bearing housing and a second bearing arranged in a second bearing housing; and
a first bearing journal disposed on a first end of the roller and a second bearing journal disposed on a second end of the roller,
wherein the first bearing journal is received by the first bearing, and the second bearing journal is received by the second bearing,
wherein the roller is mounted in the first bearing such that the roller cannot be displaced in the axial direction relative to the first bearing, so that there is a substantially constant clearance between a first front face of the roller, which radially surrounds the first bearing journal mounted in the first bearing, and first stationarely arranged components which face the first front face, and which subject the first front face of the roller to suction air,
wherein the roller is mounted in the second bearing such that the roller cannot be displaced in the axial direction relative to the second bearing, so that there is a substantially constant clearance between a second front face of the roller, which radially surrounds the second bearing journal mounted in the second bearing, and second stationarely arranged components which face the second front face, and which subject the second front face of the roller to suction air, and
wherein the second bearing housing is arranged such that the second bearing housing is axially displaceable relative to the frame.

2. The bearing structure according to claim 1, wherein the second bearing housing which is axially displaceable relative to the frame is prestressed in the radial direction against the frame.

3. The bearing structure according to claim 2, wherein the prestressing occurs via plate springs which are arranged between the second bearing housing and the frame.

4. The bearing structure according to claim 1, wherein at least one of contact surfaces between the axially displaceable second bearing housing and the frame is provided with an adhesive force-reducing element or a friction force-reducing element.

5. The bearing structure according to claim 1, further comprising:
a first control disk stationarely disposed on the first bearing housing and facing the first front face of the roller; and
a second control disk stationarely disposed on the second bearing housing and facing the second front face of the roller,
wherein the first control disk and the second control disk are operable to subject the roller to suction air in a controlled manner.

6. The bearing structure according to claim 2, wherein at least one of contact surfaces between the axially displaceable second bearing housing and the frame is provided with an adhesive force-reducing element or a friction force-reducing element.

7. The bearing structure according to claim 3, wherein at least one of contact surfaces between the axially displaceable second bearing housing and the frame is provided with an adhesive force-reducing element or a friction force-reducing element.

8. The bearing structure according to claim 2, further comprising:
a first control disk stationarely disposed on the first bearing housing and facing the first front face of the roller; and
a second control disk stationarely disposed on the second bearing housing and facing the second front face of the roller,
wherein the first control disk and the second control disk are operable to subject the roller to suction air in a controlled manner.

9. The bearing structure according to claim 3, further comprising:
a first control disk stationarely disposed on the first bearing housing and facing the first front face of the roller; and
a second control disk stationarely disposed on the second bearing housing and facing the second front face of the roller,
wherein the first control disk and the second control disk are operable to subject the roller to suction air in a controlled manner.

10. The bearing structure according to claim 4, further comprising:
a first control disk stationarely disposed on the first bearing housing and facing the first front face of the roller; and
a second control disk stationarely disposed on the second bearing housing and facing the second front face of the roller,
wherein the first control disk and the second control disk are operable to subject the roller to suction air in a controlled manner.
